(19) United States
(12) Patent Application Publication
(10) Pub. No.: US 2006/0068722 A1
(43) Pub. Date: Mar. 30, 2006

(54) Wireless communications device with extendable and retractable input/output device

(76) Inventor: William C. Ashman JR., Durham, NC (US)

Correspondence Address: COATS & BENNETT/SONY ERICSSON, 1400 CRESCENT GREEN, SUITE 300, CARY, NC, 27511, US

(21) Appl. No.: 10/951,830

(22) Filed: Sep. 28, 2004

(51) Int. Cl. H04B 1/38

(52) U.S. Cl. 455/90.3

(57) ABSTRACT

A wireless communications device has an audio transducer to facilitate communications via a wireless communications network. The audio transducer is disposed on an extendable member that is positionable in a retracted position and an extended position. When the extendable member is in the retracted position, the audio transducer is positioned internal to the housing of the wireless communications device. When the extendable member is in the extended position, the audio transducer is positioned external to the housing of the wireless communications device. An extension mechanism disposed within the housing of the wireless communications device extends the extendable member and moves the audio transducer from the retracted position within the housing to the extended position external to the housing responsive to the activation of an actuator.

### BACKGROUND

The present invention relates generally to wireless communications devices, and particularly to wireless communications devices having extendable/retractable input/output devices.

Wireless communications devices are becoming increasingly more popular. Indeed, manufacturers have introduced a steady stream of devices having new functionality and capabilities into the market place. Some of the factors that influence a consumer's purchase of a particular device are functionality and coverage area. However, just as important to the consumer are stylish looks and the size of the device. No matter how much functionality is packed into a device, consumers are usually not inclined to purchase one that is bulky or unattractive. Accordingly, there is a need to couple stylish design and small size in manufacturing wireless communications devices.

### SUMMARY

A wireless communications device comprises a housing, a transceiver to transmit signals to and receive signals from a wireless communications network, and an extendable member positionable in a retracted position and an extended position. In one embodiment of the present invention, an audio transducer is disposed on the extendable member. When the extendable member is in the retracted position, the audio transducer is positioned within the housing of the device. When the extendable member is in the extended position, the audio transducer is positioned out of or external to the housing. A user may place or receive calls, for example, to communicate with a remote party when the audio transducer is in the extended position. When the call has ended, the user retracts the audio transducer back into the retracted position.

An extension mechanism is also disposed within the housing to extend the extendable member and position the audio transducer out of the housing. In one embodiment, the extension mechanism comprises a gear having teeth that engage corresponding teeth on the extendable member. In another embodiment, the extension member comprises a sealed fluid cylinder coupled to the extendable member. A biasing member, such as a spring or compressed gas, normally biases the extendable member, and thus the audio transducer, towards the extended position. A retaining mechanism may engage the extension mechanism or the extendable member when the extendable member is in the retracted position. The retaining mechanism counteracts the biasing force to retain the extendable member and the audio transducer within the housing. An actuator disposed on the housing can disengage the retaining mechanism when the user desires to communicate, thereby allowing the biasing force to extend the extendable member and the audio transducer out of the housing.

Some embodiments of the present invention comprise first and second extendable members, both of which are positionable in the retracted and extended positions. An input device and an output device, for example, a speaker and a microphone, or a camera and flash device, are disposed on the first and second extendable members, respectively. As in the previous embodiments, the biasing member biases the input device and output device out of the housing, while the retaining member counteracts the biasing force to retain the input device and output device within the housing. Activation of the actuator by the user disengages the retaining member and permits the extension mechanism to extend the first and/or second extendable members.

### BRIEF DESCRIPTION OF THE DRAWINGS

FIG. 1 illustrates a block diagram of a wireless communications device according to one embodiment of the present invention.

FIGS. 2A and 2B illustrate a perspective view of a wireless communications device according to one embodiment of the present invention.

FIGS. 3A and 3B illustrate an extension mechanism according to one embodiment of the present invention.

FIGS. 4A and 4B illustrate an alternate extension mechanism according to another embodiment of the present invention.

FIGS. 5A and 5B illustrate a perspective view of a wireless communications device according to an alternate embodiment of the present invention.

FIGS. 6A and 6B illustrate a perspective view of a wireless communications device according to another embodiment of the present invention.

FIG. 7 illustrates a perspective view of a wireless communications device according to yet another embodiment of the present invention.

### DETAILED DESCRIPTION

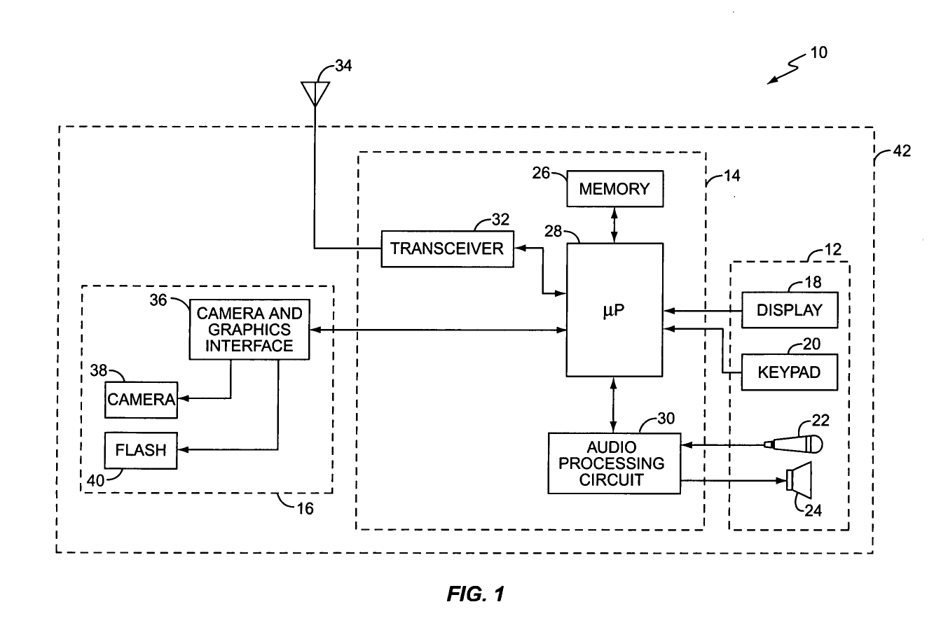

Referring now to the drawings, FIG. 1 illustrates a camera-equipped wireless communications device 10 according to the present invention. While the figures illustrate device 10 in terms of a camera-equipped cellular telephone, those skilled in the art will readily appreciate that the present invention is applicable to any consumer electronics device with or without media imaging capability including, but not limited to, Personal Digital Assistants (PDAs), cellular telephones, satellite telephones, Personal Communication Services (PCS) devices, palm computers, or the like.

As seen in FIG. 1, device 10 comprises a user interface 12, a communications circuit 14, a camera assembly 16, and a housing 42. User interface 12 includes a display 18, a keypad 20, a microphone 22, and a speaker 24. Display 18 permits users to view dialed digits, call status, menu options, and other service information. Display 18 also acts as a viewfinder, and permits users to view images captured by camera assembly 16. Keypad 20, disposed on a face of device 10, includes an alphanumeric keypad and other input controls such as a joystick, button controls, or dials. Keypad 20 allows the operator to dial numbers, enter commands, and select options from menu systems. Additionally, keypad 20 permits the user to control the functionality of camera assembly 16.

Microphone 22 converts the user's speech into electrical audio signals, and speaker 24 converts audio signals into audible sounds that can be heard by the user. Microphone 22 and speaker 24 may be any type of audio transducer known in the art. As will be described in more detail below, microphone 22 and/or speaker 24 may be positioned on extendable members that are positionable in a retracted position and an extended position. When the extendable members are in the retracted position, microphone 22 and/or speaker 24 are within the housing 42 of device 10 (i.e., internal to device 10). When the extendable members are in the extended position, microphone 22 and/or speaker 24 are out of the housing of device 10 (i.e., external to the device 10).

Communications circuit 14 comprises memory 26, a system processor 28, an audio processing circuit 30, and a transceiver 32 having an antenna 34. Memory 26 may include both random access memory (RAM) and read-only memory (ROM). Computer program instructions and data required for operation are stored in non-volatile memory, such as EPROM, EEPROM, and/or flash memory, and may be implemented as discrete devices, stacked devices, or integrated with system processor 28.

System processor 28 controls the operation of device 10 according to programs stored in memory 26, and may use known techniques to digitally alter images captured by camera 38. The control functions may be implemented in a single microprocessor, or in multiple microprocessors. Suitable system processors 28 may include, for example, both general purpose and special purpose microprocessors and digital signal processors. System processor 28 may interface with audio processing circuit 30, which provides basic analog output signals to speaker 24 and receives analog audio inputs from microphone 22. System processor 28 may also control the operation of camera assembly 16 responsive to control signals input by the user on keypad 20, for example.

Transceiver 32 is coupled to antenna 34 for receiving and transmitting signals from and to one or more base stations in a wireless communications network. Transceiver 32 is a fully functional cellular radio transceiver, and operates according to any known standard, including Global System for Mobile Communications (GSM), TIA/EIA-136, cdmaOne, cdma2000, UMTS, and Wideband CDMA.

Camera assembly 16 includes a camera and graphics interface 36, a camera 38, and an optional integrated flash 40. Camera assembly 16 may be any camera assembly known in the art, and may further include such elements as a lens assembly (not shown), an image sensor (not shown), and an image processor (not shown). Camera and graphics interface 36 interfaces camera assembly 16 with system processor 28. As is known in the art, an image processor (not shown) may be interposed between camera and graphics interface 36 and camera 38 and/or flash device 40 to control camera 38 and/or flash device 40 and process images. While the camera and graphics interface 36 is shown as a separated component in FIG. 1, it should be understood that camera and graphics interface 36 may be incorporated with the image processor or system processor 28.

Camera assembly 16 captures images that can be digitized and stored in memory 26, digitally altered by system processor 28, output to display 18, or transmitted over a wireless network via long-range transceiver 32. Flash device 40 emits a flash of light to illuminate, if required, the subject of the image being captured. Like microphone 22 and speaker 24, camera 38 and flash device 40 may be disposed on first and second extendable members that are positionable in a retracted position and an extended position. When the extendable members are in the retracted position, camera 38 and/or flash device 40 are within the housing 42 of device 10 (i.e., internal to device 10). When the extendable members are in the extended position, camera 38 and/or flash device 40 are out of the housing of device 10 (i.e., external to the device 10).

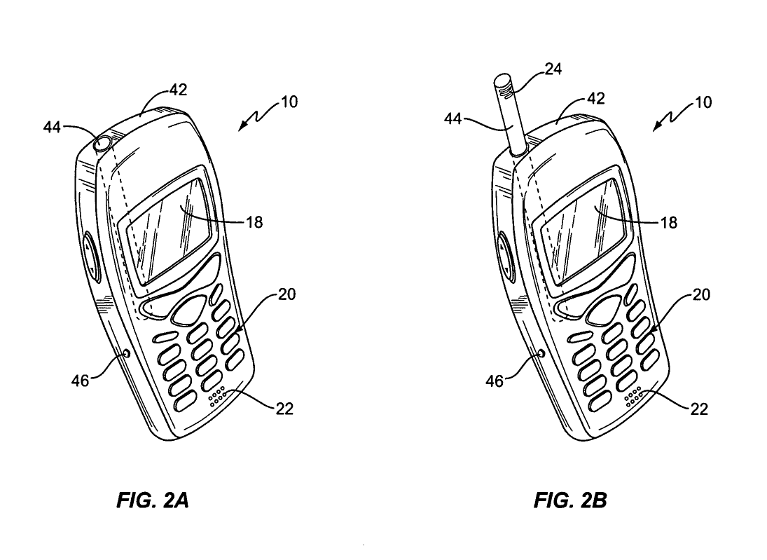

FIGS. 2A and 2B illustrate a wireless communications device 10 configured according to one embodiment of the present invention. As seen in FIGS. 2A and 2B, an extendable member 44 is positionable in a retracted position within the housing 42 of device 10 (FIG. 2A), and an extended position out of the housing 42 of device 10 (FIG. 2B). The extendable member 44 slides through an opening in housing 42 when moving between the retracted and extended positions. In FIG. 2, speaker 24 is disposed on extendable member 44 and microphone 22 is conventionally disposed on a front face of housing 42. However, as will be described in more detail later, microphone 24 can also be on an extendable member in place of or in addition to speaker 24.

In this embodiment, extendable member 44 is shaped as a post and is constructed from materials similar to the housing 42 of device 10. However, those skilled in the art will readily appreciate that the present invention is not so limited, and that extendable member may be any shape and constructed of any material desired. Additionally, while not specifically shown in the figures, a member such as a brush or grommet (not shown) may surround the opening through which extendable member 44 slides to prevent dirt, moisture, and other particulate matter from falling through the opening and into the interior of device 10. Preferably, the brush or grommet has a low co-efficient of friction so as to not inhibit the movement of extendable member 44 between the retracted and extended positions.

When device 10 is not in use for communicating with remote parties, for example, extendable member 44 is retracted into housing 42. In the retracted position, the body of extendable member 44 lies generally within the interior of housing 42 with a top face of extendable member 44 being substantially even with the top face of housing 42. In addition, speaker 24 is contained within the housing 42. This position facilitates a reduced form factor for device 10 without diminishing the size of display 18 and keypad 20. In fact, by enabling the extendable member 44 to slide within housing 42, the present invention permits displays 18 and/or keyboards 20 that are of a larger than normal design.

When the user wishes to make or receive a call, for example, the user activates an actuator 46 disposed on housing 42. Responsive to the actuator 46, extendable member 44 extends out of the housing 42. In the extended position, extendable member 44 is at least partially extended out of the housing 44. In addition, speaker 24 is also exposed so that the user may hear audible sounds emanating from speaker 24. Any wiring, leads, cabling, or circuitry needed for the operation of speaker 24 may be run through an interior portion of extendable member 44. For example, where speaker 24 comprises a conic or flat-panel speaker, wires and/or leads connecting the speaker 24 to the audio processing circuit 30 are contained within the interior of extendable member. Alternatively, the interior of extendable member may be substantially hollow to allow sound waves to propagate through extendable member 44 to speaker 24.

When the call is complete, the user may return extendable member 44 and speaker 24 to the retracted position within the housing 42 by applying an appropriate force on the top face of extendable member 44. In the embodiment of FIG. 2, for example, the user needs only to push the extendable member 44 back into the housing 42.

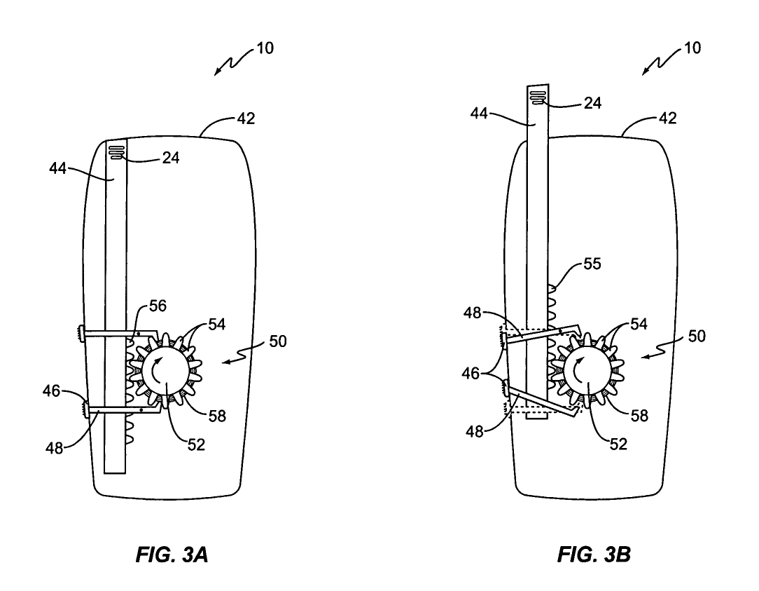

FIGS. 3A and 3B illustrate device 10 with a face of housing 42 removed to expose an exemplary extension mechanism 50 according to one embodiment of the present invention. The extension mechanism 50 extends the extendable member 44 and the speaker 24 to the extended position. In FIG. 3A, extendable member 44 and speaker 24 are shown in the retracted position, while in FIG. 3B, extendable member 44 and speaker 24 are shown in the extended position.

Extension mechanism 50 is disposed within housing 42 and comprises a gear 52 having one or more teeth 54 and a biasing member 58. The biasing member 58, which in FIGS. 3A and 3B comprises a coiled leaf spring, biases gear 52 to rotate in the direction of the arrow. Alternatively, a conventional compression coil spring could be used to bias extendable member 44 directly without the need for gear 52. Biasing member 58 may be anchored on one end to gear 52 and on the other end to housing 42. Thus, moving extendable member 44 to the retracted position, for example, by pushing the extendable member 44 into housing 42, causes biasing member 58 to coil or tighten. In this state, biasing member 58 stores the energy that will be used to extend the extendable member 44 through the opening and into the extended position. Teeth 54 engage corresponding teeth 56 on extendable member 44, and thus, biasing member 58 also biases the extendable member 44 toward the extended position. When gear 52 rotates in the direction of the arrow, teeth 54 engage teeth 56 and move extendable member 44 and speaker 24 out of the housing 42.

To retain the extendable member 44 within the housing 42, a retaining member 48 releasably couples to gear 52 and counteracts the biasing force imposed on gear 52 by biasing member 58 (FIG. 3A). Retaining member 48 is also connected to actuator 46, which in this embodiment slides along housing 42. The retaining member 48 counteracts the biasing force imposed by biasing member 58 by preventing the rotation of gear 52. To release the gear 52 and thereby allow the extendable member to extend out of the housing 42, the user moves the actuator from a first position to a second position (FIG. 3B). This causes the retaining member 48 to disengage gear 52 allowing free rotation of gear 52 and the extension of extendable member 44 and speaker 24.

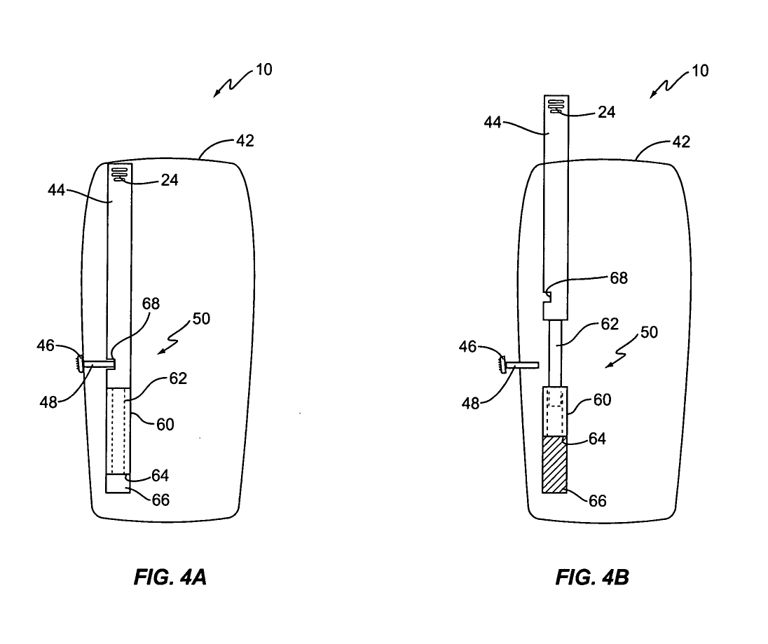

In FIGS. 3A and 3B, the actuator 46 and/or retaining member 48 is positioned so that the retaining member 48 contacts gear 52 at the top and/or bottom of gear 52. However, those skilled in the art will appreciate that other devices and positions for retaining extendable member 44 exist. FIGS. 4A and 4B, for example, illustrate an alternate embodiment wherein extension mechanism 50 comprises a fluid cylinder. In this embodiment, extension mechanism 50 comprises a sealed cylinder 60 having a compressible fluid or gas, such as air 66, therein. A lower portion 62 of extendable member 44 slides into and out of the sealed cylinder 60. When the extendable member 44 and speaker 24 are in the retracted position (FIG. 4A), a plunger 64 is forced downwardly and compresses air 66.

The compressed air 66 normally pushes on plunger 64 to bias the extendable member 44 and speaker 24 into the extended position. Therefore, retaining member 48 mates with a corresponding slot or opening 68 in extendable member 44 to retain extendable member 44 and speaker 24 within the housing 42. To release the extendable member 44, the user pulls the actuator 46 away from the housing 42 to disengage retaining member 48 from the slot or opening 68. When released, the compressed air 66 expands pushing upwardly on plunger 64 and extendable member 44 to extend the speaker 24 out of the housing (FIG. 4B). As in the previous embodiment, the user merely pushes the extendable member 44 back into the housing 42 to return speaker 24 to the retracted position, and replaces the retaining member 48 into the corresponding slot or opening 68.

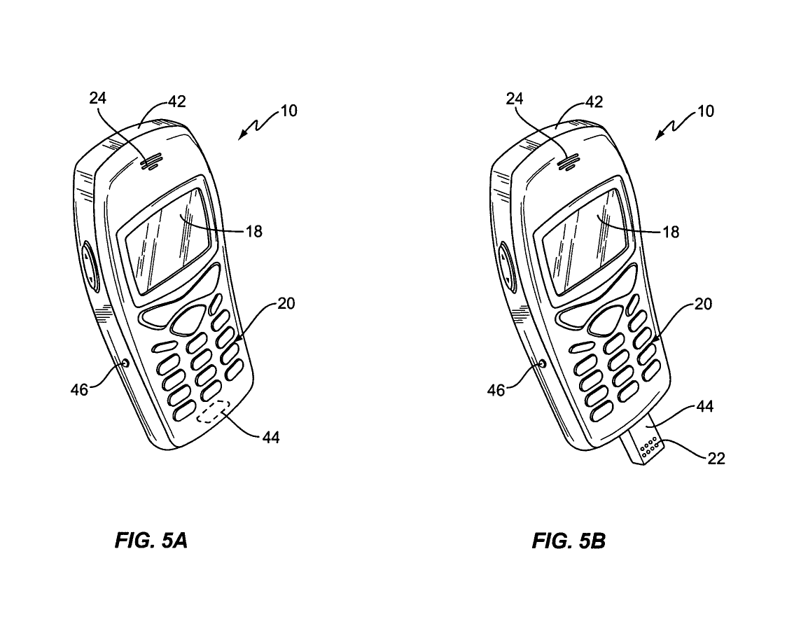

The aforementioned embodiments illustrated the present invention as having an audio transducer, and specifically a speaker 24, disposed on the extendable member 44 such that speaker 24 could be retracted within the housing or extended out of the housing based on the position of the extendable member 44. In an alternate embodiment, shown in FIGS. 5A and 5B, the audio transducer disposed on the extendable member 44 comprises microphone 22 with speaker 24 being conventionally disposed on a face of housing 42. In this embodiment, extendable member 44 moves to the extended position out of the housing 42 when the user activates actuator 46. Like the previous embodiment, this embodiment employs a retaining member 48 and an extension mechanism 50 to retain and extend the microphone 22 in and out of the housing 42, respectively.

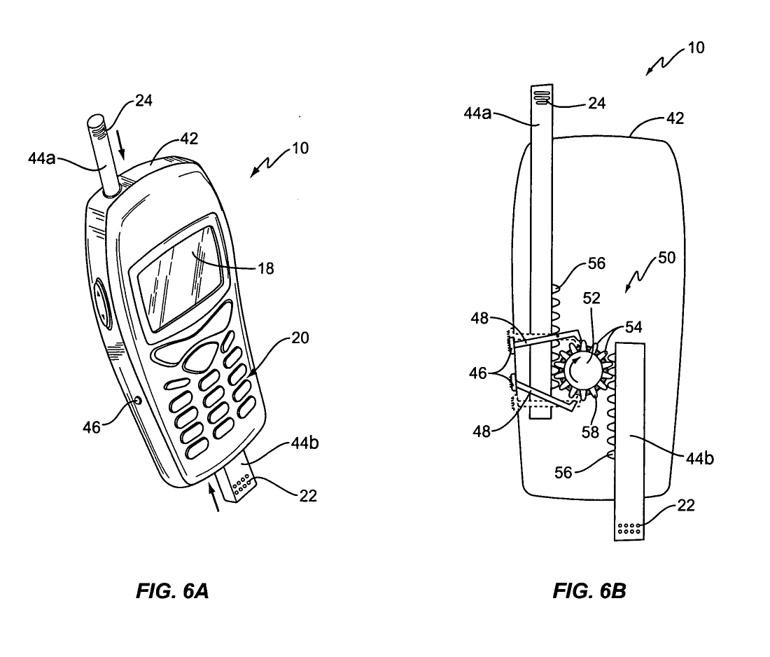

In FIGS. 6A and 6B, another embodiment of the present invention is shown wherein a pair of audio transducers is disposed on first and second extendable members 44a and 44b, respectively. In this case, the microphone 22 comprises an input device, and the speaker 24 comprises an output device. Further, first and second extendable members 44a, 44b may be extended out of the housing 42 using either of the embodiments of extension mechanism 50, and retained within the housing 42 using retaining member 48. Particularly, as seen in FIG. 6B, extension mechanism 50 is used to extend the first and second extendable members 44a, 44b, and their associated transducers 22, 24 to the extended position. Additionally, retaining member 48 opposes the biasing force by preventing the rotation of gear. Thus, in this embodiment, both extendable members 44a, 44b extend together when the user actuates actuator 46. However, it should be understood that each extendable member 44a, 44b may each have its own extension mechanism 50, as well as its own actuator 46 and retaining member 48. In these embodiments, first and second extendable members 44, and thus microphone 22 and speaker 24, may be separately extended and retracted.

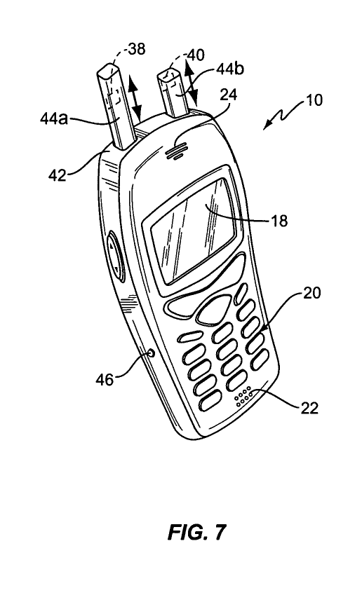

In addition to audio transducers, the present invention also contemplates other types of devices disposed on extendable members 44a and 44b. In FIG. 7, for example, camera 38 and flash device 40 are disposed on first and second extendable members 44a and 44b. Extendable members 44a, 44b, and thus, camera 38 and flash device 40, are retained within the housing 42 in the retracted position via retaining member 48, and extended out of the housing 42 via extension mechanism 50 as previously described. Further, any cabling, wiring, or other circuitry needed or desired for the operation of camera 38 and/or flash device 40 may extend through the interior of their respective extendable members 44a, 44b to the appropriate circuitry within device 10. In this embodiment, camera 38 and flash device 40 face away from the display 18 so that display 18 may be employed as a viewfinder.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A wireless communications device comprising:
a housing;
an extendable member positionable in a retracted position and an extended position; and
an audio transducer disposed on the extendable member, the audio transducer being retracted within the housing when the extendable member is in the retracted position, and extended out of the housing when the extendable member is in the extended position.

2. The device of claim 1 further comprising an extension mechanism to extend the audio transducer out of the housing.

3. The device of claim 1 further comprising a retaining member to retain the audio transducer within the housing.

4. The device of claim 1 further comprising an actuator to extend the audio transducer from the retracted position to the extended position.

5. The device of claim 2 wherein the extension mechanism comprises a gear having one or more teeth that engages corresponding teeth on the extendable member.

6. The device of claim 5 wherein the extension mechanism further comprises a biasing member to bias the extendable member towards the extended position.

7. The device of claim 2 wherein the extension mechanism comprises a fluid cylinder to bias the extendable member towards the extended position.

8. The device of claim 1 wherein the audio transducer comprises a microphone.

9. The device of claim 1 wherein the audio transducer comprises a speaker.

10. A wireless communications device comprising:
a transceiver within a housing to transmit data to and receive data from a wireless communications network
a first extendable member including an input device positionable within the housing and out of the housing;
a second extendable member including an output device positionable within the housing and out of the housing; and
an actuator to extend the input and output devices from within the housing to out of the housing.

11. The device of claim 10 further comprising a retaining member to retain the input and output devices within the housing.

12. The device of claim 10 further comprising an extension mechanism to extend the input and output devices out of the housing responsive to the activation of the actuator.

13. The device of claim 12 wherein the extension mechanism comprises a gear having one or more teeth that engages corresponding teeth on the first and second extendable members.

14. The device of claim 12 wherein the extension mechanism further comprises a biasing member to bias the input and output devices out of the housing.

15. The device of claim 11 wherein the extension mechanism comprises first and second fluid cylinders coupled to the first and second extendable members, respectively.

16. The device of claim 15 wherein the first and second fluid cylinders bias the input and output devices out of the housing.

17. The device of claim 11 further comprising first and second extension mechanisms to extend the input and output devices out of the housing, respectively.

18. The device of claim 17 wherein each of the first and second extension mechanisms include a gear and a biasing member to bias the input and output devices out of the housing.

19. The device of claim 10 wherein the input device is a microphone and the output device is a speaker.

20. The device of claim 10 wherein the input device is an image capturing device, and the output device is a flash device.

21. A wireless communications device comprising:
a transceiver to transmit data to and receive data from a wireless communications network;
a housing;
at least one of an input device and an output device positionable in a retracted position within the housing and an extended position out of the housing; and
an actuator on the housing to release the at least one of the input device and the output device to move from the retracted position to the extended position.

22. The device of claim 21 further comprising a first extendable member positionable in the retracted position and the extended position, wherein the at least one of the input device and the output device is disposed on the first extendable member

23. The device of claim 22 further comprising a second extendable member positionable in the retracted position and the extended position, wherein the other of the input device and the output device is disposed on the second extendable member.

24. The device of claim 21 further comprising an extension mechanism to extend the at least one of the input device and the output device out of the housing.

25. The device of claim 21 further comprising a retaining member to retain the at least one of the input device and the output device within the housing.

26. The device of claim 21 wherein the at least one of the input device and the output device comprises an audio transducer.

27. The device of claim 21 wherein the input device comprises a camera.

28. The device of claim 21 wherein the output device comprises a flash device.

29. A method of communicating over a wireless communications device, the method comprising:
retaining a first audio transducer in a first retracted position internal to a housing of the wireless communications device;
biasing a first audio transducer from the first retracted position to a first extended position external to the wireless communications device; and
extending the first audio transducer from the first retracted position to the first extended position.

30. The method of claim 29 wherein extending the first audio transducer from the first retracted position to the first extended position comprises manipulating an actuator disposed on the housing of the wireless communications device.

31. The method of claim 29 further comprising retaining a second audio transducer in a second retracted position internal to the housing of the wireless communications device.

32. The method of claim 31 further comprising biasing the second audio transducer from the second retracted position to a second extended position external to the wireless communications device.

33. The method of claim 32 wherein extending the first and second audio transducers from the first and second retracted positions to the first and second extended positions comprises manipulating one or more actuators disposed on the housing of the wireless communications device.

34. A wireless communications device comprising:
a transceiver to transmit data to and receive data from a wireless communications network;
a housing;
a first extendable member positionable in a first retracted position within the housing and a first extended position out of the housing; and
an image capturing device on the first extendable member, the image capturing device positionable in the first retracted position and the first extended position.

35. The device of claim 34 further comprising an extension mechanism to extend the image capturing device from the first retracted position to the first extended position.

36. The device of claim 35 wherein the extension mechanism comprises a biasing member that biases the image capturing device towards the first extended position.

37. The device of claim 34 further comprising a second extendable member having a flash device, the second extendable member and the flash device positionable in a second retracted position within the housing and a second extended position out of the housing.

38. The device of claim 37 further comprising an extension mechanism to extend the image capturing device from the first retracted position to the first extended position, and the flash device from the second retracted position to the second extended position.

39. The device of claim 38 wherein the extension mechanism comprises a biasing member that biases the image capturing device and the flash device out of the housing.
